(19) United States
(12) Patent Application Publication
(10) Pub. No.: US 2010/0271363 A1
(43) Pub. Date: Oct. 28, 2010

(54) ORGANIC LIGHT EMITTING DISPLAY AND DRIVING METHOD THEREOF

(76) Inventor: Bo-Yong Chung, Yongin-city (KR)

Correspondence Address: CHRISTIE, PARKER & HALE, LLP, PO BOX 7068, PASADENA, CA, 91109-7068, US

(21) Appl. No.: 12/702,531

(22) Filed: Feb. 9, 2010

(30) Foreign Application Priority Data
Apr. 23, 2009 (KR) 10-2009-0035413

(51) Int. Cl. G06F 3/038

(52) U.S. Cl. 345/213; 345/82

(57) ABSTRACT

An organic light emitting display includes a scan driver for sequentially supplying a scan signal to scan lines; a data driver for supplying data signals to data lines when the scan signal is supplied; a timing controller for controlling the scan driver and the data driver and for supplying one of at least two clock signals to clock supply lines arranged parallel to the scan lines; and pixels positioned at crossing regions of the scan lines, the data lines and the clock supply lines. Each of the pixels includes an organic light emitting diode; a pixel circuit for controlling an amount of current supplied along a current path from a first power source to a second power source via the organic light emitting diode; and a control transistor on the current path and controlled by a corresponding clock signal of the at least two clock signals.

### CROSS-REFERENCE TO RELATED APPLICATIONS

This application claims priority to and the benefit of Korean Patent Application No. 10-2009-0035413, filed on Apr. 23, 2009, in the Korean Intellectual Property Office, the entire content of which is incorporated herein by reference.

### BACKGROUND

1. Field

The following description relates to an organic light emitting display and a driving method thereof.

2. Description of the Related Art

Recently, various types of flat panel displays having reduced weight and volume as compared to cathode ray tubes have been developed. Such flat panel displays include liquid crystal displays, field emission displays, plasma display panels, and organic light emitting displays, among others.

Among these flat panel displays, the organic light emitting display displays images using organic light emitting diodes that emit light through the recombination of electrons and holes. The organic light emitting display has fast response times and is driven with low power consumption. In a related art organic light emitting display, light is emitted from an organic light emitting diode by supplying current corresponding to a data signal using a driving transistor formed in each pixel.

FIG. 1 is a block diagram of a related art organic light emitting display.

Referring to FIG. 1, the related art organic light emitting display includes a display region 40 having a plurality of pixels 50 coupled to scan lines S1 to Sn, data lines D1 to Dm and emission control lines E1 to En; a scan driver 10 for driving the scan lines S1 to Sn; a data driver 20 for driving the data lines D1 to Dm; an emission control driver 30 for driving the emission control lines E1 to En; and a timing controller 60 for controlling the scan driver 10, the data driver 20 and the emission control driver 30.

The scan driver 10 sequentially supplies a scan signal to the scan lines S1 to Sn under the control of the timing controller 60. Then, the pixels 50 coupled to the scan lines S1 to Sn are sequentially selected.

The data driver 20 supplies data signals to the data lines D1 to Dm under the control of the timing controller 60. Whenever a scan signal is supplied from the scan driver 10, the data driver 20 supplies data signals to the data lines D1 to Dm. the data signals are respectively supplied to pixels 50 selected by the scan signal, and a voltage corresponding to each data signal is respectively charged into the respective pixel 50.

The emission control driver 30 sequentially supplies an emission control signal to the emission control lines E1 to En under the control of the timing controller 60. Generally, the emission control driver 30 supplies an emission control signal so that pixels 50 do not emit light during the period when data signals are being supplied to the respective pixels.

In the related art light emitting display described above, since the emission time of the pixels 50 is controlled using the emission control lines E1 to En, the emission control driver 30 is included in the light emitting display device. Therefore, manufacturing costs are increased.

### SUMMARY OF THE INVENTION

Accordingly, exemplary embodiments of the present invention provide for an organic light emitting display with reduced manufacturing costs, and a driving method thereof.

According to an aspect of an exemplary embodiment of the present invention, there is provided an organic light emitting display, which includes a scan driver for sequentially supplying a scan signal to scan lines; a data driver for supplying data signals to data lines when the scan signal is supplied; a timing controller for controlling the scan driver and the data driver and for supplying one of at least two clock signals to clock supply lines arranged parallel to the scan lines; and pixels positioned at crossing regions of the scan lines, the data lines and the clock supply lines, wherein each of the pixels includes an organic light emitting diode; a pixel circuit for controlling an amount of current supplied along a current path from a first power source to a second power source via the organic light emitting diode; and a control transistor on the current path and controlled by a corresponding clock signal of the at least two clock signals.

In one embodiment, the timing controller may be configured to supply a first clock signal of the at least two clock signals to odd-numbered clock supply lines of the clock supply lines and to supply a second clock signal of the at least two clock signals to even-numbered clock supply lines of the clock supply lines. The first clock signal may be configured to turn off the control transistor of a pixel corresponding to one of the odd-numbered clock supply lines of the pixels when the scan signal is supplied to odd-numbered scan lines of the scan lines, and to turn on the control transistor of the pixel when the scan signal is not supplied to the odd-numbered scan lines. The second clock signal may be configured to turn off the control transistor of a pixel corresponding to one of the even-numbered clock supply lines of the pixels when the scan signal is supplied to even-numbered scan lines of the scan lines, and to turn on the control transistor of the pixel when the scan signal is not supplied to the even-numbered scan lines. In one embodiment, the scan signal may be sequentially supplied to odd-numbered scan lines of the scan lines during an i-th (i is an odd or even number) frame period, and may be sequentially supplied to even-numbered scan lines of the scan lines during an (i+1)-th frame period. The first clock signal may be configured to turn off the control transistor of a pixel corresponding to one of the odd-numbered clock supply lines of the pixels during the i-th frame period, and to turn on the control transistor of the pixel during the (i+1)-th frame period. The second clock signal may be configured to turn off the control transistor of a pixel corresponding to one of the even-numbered clock supply lines of the pixels during the (i+1)-th frame period, and to turn on the control transistor of the pixel during the i-th frame period. In one embodiment, the timing controller may be configured to supply a first clock signal of the at least two clock signals to j-th (j is 1, 5, 9, . . . ) clock supply lines of the clock supply lines, to supply a second clock signal of the at least two clock signals to (j+1)-th clock supply lines of the clock supply lines, to supply a third clock signal of the at least two clock signals to (j+2)-th clock supply lines of the clock supply lines, and to supply a fourth clock signal of the at least two clock signals to (j+3)-th clock supply lines of the clock supply lines. Each of the first, second, third, and fourth clock signals may overlap with a portion of the scan signal being supplied to one of two scan lines, and may completely overlap with a scan signal being supplied to the other one of the two scan lines.

According to an aspect of another exemplary embodiment of the present invention, there is provided a method of driving an organic light emitting display, which includes sequentially supplying a scan signal to scan lines; supplying data signals to data lines when the scan signal is supplied; and supplying one of at least two clock signals to clock supply lines arranged parallel to the scan lines to turn corresponding control transistors of pixels on and off.

In an organic light emitting display and a driving method thereof according to exemplary embodiments of the present invention, the emission time of pixels can be controlled using clock signals, thereby reducing manufacturing costs. Further, when using clock signals, pixels are repeatedly in emission and non-emission states, thereby minimizing or reducing a motion blur phenomenon.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a schematic block diagram of a prior art organic light emitting display.

FIG. 2 is a schematic block diagram of an organic light emitting display according to an embodiment of the present invention.

FIG. 3 is a circuit diagram illustrating an embodiment of a pixel illustrated in FIG. 2.

FIG. 4 is a circuit diagram illustrating another embodiment of a pixel illustrated in FIG. 2.

FIG. 5 is a circuit diagram illustrating still another embodiment of a pixel illustrated in FIG. 2.

FIG. 6 is a waveform diagram illustrating a driving method according to a first embodiment of the present invention.

FIG. 7 is a waveform diagram illustrating a driving method according to a second embodiment of the present invention.

FIG. 8 is a waveform diagram illustrating a driving method according to a third embodiment of the present invention.

FIG. 9 is a waveform diagram illustrating a driving method according to a fourth embodiment of the present invention.

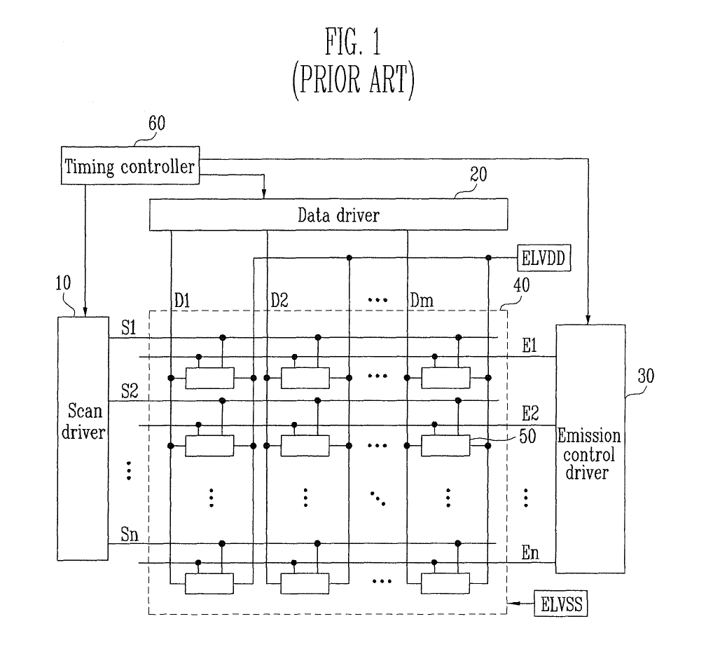

### DETAILED DESCRIPTION

Hereinafter, certain exemplary embodiments according to the present invention will be described with reference to the accompanying drawings. Here, when a first element is described as being coupled to a second element, the first element may be directly coupled to the second element, or may be indirectly coupled to the second element via one or more additional elements. Further, some of the elements that are not essential to the complete understanding of the invention are omitted for clarity. Also, like reference numerals refer to like elements throughout.

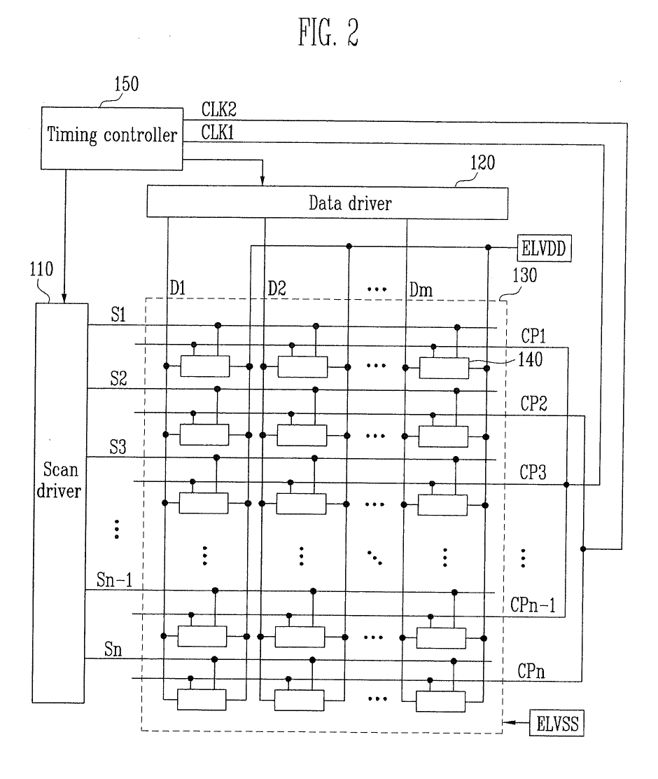

FIG. 2 is a schematic block diagram of an organic light emitting display according to an embodiment of the present invention.

Referring to FIG. 2, the organic light emitting display according to the embodiment of the present invention includes a display region 130 having a plurality of pixels 140 positioned at crossing regions of scan lines S1 to Sn, data lines D1 to Dm and clock supply lines CP1 to CPn; a scan driver 110 for driving the scan lines S1 to Sn; a data driver 120 for driving the data lines D1 to Dm; a timing controller 150 for supplying either clock signal CLK1 or CLK2 to each of the clock supply lines CP1 to CPn and controlling the scan and data drivers 110 and 120.

The scan driver 110 sequentially supplies a scan signal to the scan lines S1 to Sn under the control of the timing controller 150. Accordingly, the pixels 140 coupled to the scan lines S1 to Sn are sequentially selected.

The data driver 120 supplies data signals to the data lines D1 to Dm under the control of the timing controller 150. When a scan signal is supplied from the scan driver 110, the data driver 120 supplies data signals to the data lines D1 to Dm. Then, data signals are supplied to pixels 140 selected by the scan signal, and voltages corresponding to the data signals respectively supplied to the pixels 140 are charged into the respective pixels.

Odd-numbered clock supply lines CP1, CP3, . . . , CPn−1 are electrically coupled to one another and receive a first clock signal CLK1 supplied from the timing controller 150. Even-numbered clock supply lines CP2, CP4, . . . , CPn are electrically coupled to one another and receive a second clock signal CLK2 supplied from the timing controller 150.

That is, in the embodiment of the present invention, the emission time of pixels 140 positioned on an odd-numbered horizontal line is controlled by the first clock signal CLK1, and the emission time of pixels 140 positioned on an even-numbered horizontal line is controlled by the second clock signal CLK2. In the organic light emitting display according to the embodiment of the present invention, a separate driver for emission time control is not used, and accordingly, manufacturing costs can be reduced.

FIG. 3 is a circuit diagram illustrating a driving method of a pixel according to the embodiment of the present invention. For convenience of illustration, a pixel 140 coupled to an m-th data line Dm and an n-th scan line Sn is illustrated in FIG. 3.

Referring to FIG. 3, the pixel 140 includes an organic light emitting diode OLED; a pixel circuit 142 for supplying current to the organic light emitting diode OLED; and a control transistor MC coupled between the pixel circuit 142 and the organic light emitting diode OLED.

A cathode electrode of the organic light emitting diode OLED is coupled to a second power source ELVSS, and an anode electrode of the organic light emitting diode OLED is coupled to the control transistor MC. The organic light emitting diode OLED generates light with a luminance (e.g., a predetermined luminance) corresponding to an amount of current supplied from the pixel circuit 142.

When a scan signal is supplied to the pixel circuit 142, a voltage corresponding to a data signal is charged into the pixel circuit 142. The pixel circuit 142 supplies current corresponding to the data signal from a first power source ELVDD to the second power source ELVSS via the organic light emitting diode OLED. To this end, the pixel circuit 142 has at least a transistor and a capacitor. In the embodiment of the present invention, the pixel circuit 142 may be selected from various types of circuits currently known in the art.

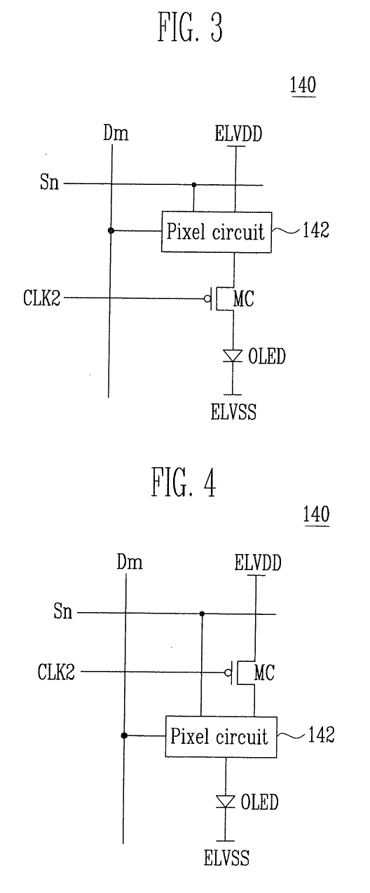

The control transistor MC is turned on or off in response to a clock signal CLK2. Depending on a position of the pixel 140 in the display, the control transistor MC may instead be controlled by a different corresponding clock signal. Here, the control transistor MC is controlled to be turned off during the period when a data signal is supplied to the pixel circuit 142. In the embodiment of the present invention, the position of the control transistor MC may be variously determined. For example, the control transistor MC may be coupled between the pixel circuit 142 and the first power source ELVDD as illustrated in FIG. 4.

In FIGS. 3 and 4, the control transistor MC is illustrated as a PMOS type control transistor. However, the present invention is not limited thereto. For example, the control transistor MC may alternatively be formed as an NMOS type transistor, as illustrated in FIG. 5.

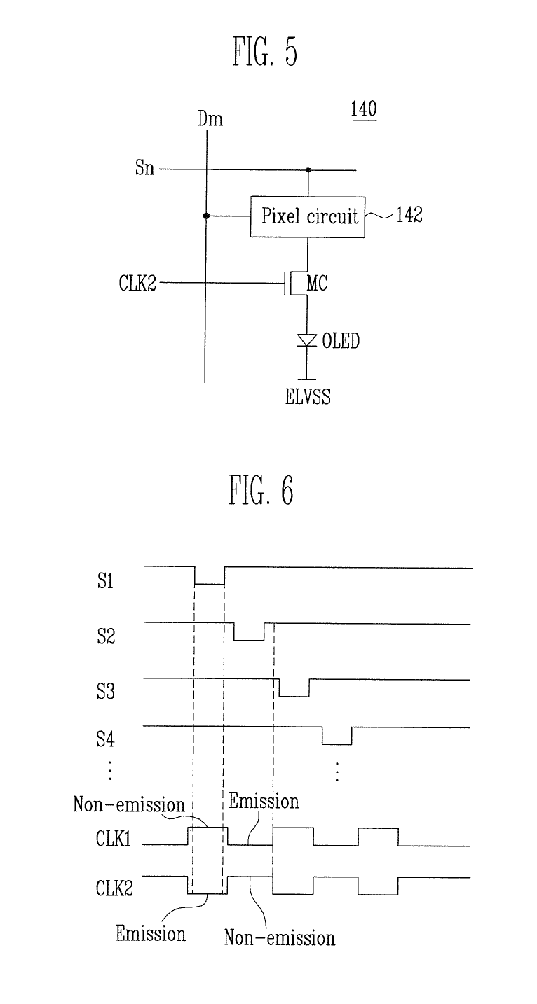

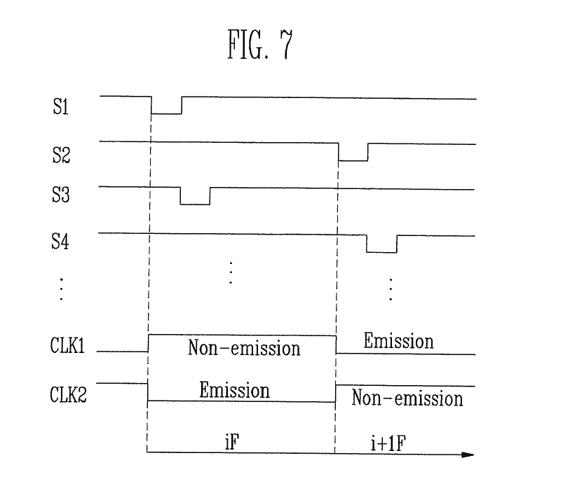

FIG. 6 is a waveform diagram illustrating a driving method according to a first embodiment of the present invention. For convenience, it is assumed that the control transistor MC is a PMOS transistor.

Referring to FIG. 6, a scan signal is sequentially supplied to the scan lines S1 to Sn.

A first clock signal CLK1 is supplied to odd-numbered clock supply lines CP1, CP3, . . . , CPn−1. Here, the first clock signal CLK1 is set to have a high voltage (i.e., a voltage at which pixels do not emit light) during periods when a scan signal is supplied to odd-numbered scan lines S1, S3, . . . , and to have a low voltage (i.e., a voltage at which pixels may emit light) during periods when the scan signal is supplied to even-numbered scan lines S2, S4, . . . . In this case, pixels 140 coupled to the odd-numbered scan lines S1, S3, . . . are set to be in a non-emission state during periods when the scan signal is supplied to the odd-numbered scan lines S1, S3, . . . and to be in an emission state during periods when the scan signal is not supplied to the odd-numbered scan lines.

A second clock signal CLK2 is supplied to even-numbered clock supply lines CP2, CP4, CPn. Here, the second clock signal CLK2 is set to have a high voltage (i.e., a voltage at which pixels do not emit light) during periods when a scan signal is supplied to even-numbered scan lines S2, S4, . . . and to have a low voltage (i.e., a voltage at which pixels may emit light) during periods when the scan signal is supplied to odd-numbered scan lines S1, S3, . . . . In this case, pixels 140 coupled to the even-numbered scan lines S2, S4, . . . are set to be in a non-emission state during periods when the scan signal is supplied to the even-numbered scan lines S2, S4, . . . and to be in an emission state during periods when the scan signal is not supplied to the even-numbered scan lines.

In the first embodiment of the present invention, the pixels 140 are alternately in an emission state or in a non-emission state corresponding to horizontal line arrangement, and based on horizontal periods (e.g., a period of 1H, or a period when a scan signal is supplied to one scan line). In this case, a motion blur phenomenon can be minimized or reduced, and images with enhanced or improved image quality can be displayed.

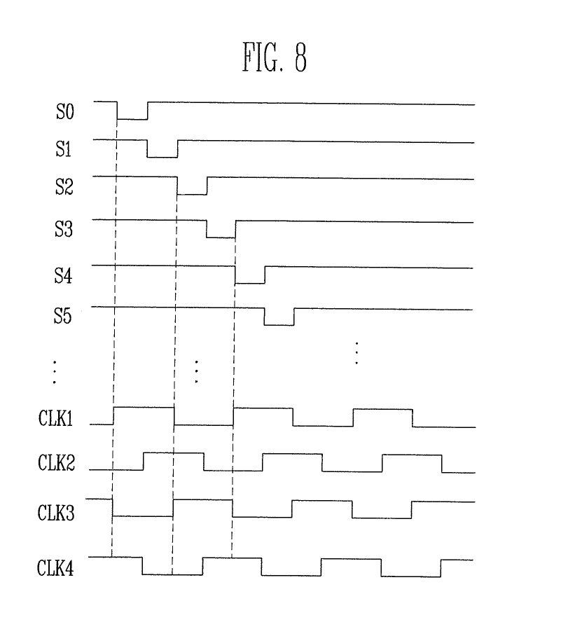

FIG. 7 is a waveform diagram illustrating a driving method according to a second embodiment of the present invention. For convenience, it is assumed that the control transistor MC is a PMOS transistor.

Referring to FIG. 7, a scan signal is sequentially supplied to the odd-numbered scan lines 51, S3, . . . during an i-th (i is an odd or even number) frame period iF. During this time, a first clock signal CLK1 supplied to the odd-numbered clock supply lines CP1, CP3, . . . , CPn−1 has a high voltage, and a second clock signal CLK2 supplied to the even-numbered clock supply lines CP2, CP4, . . . , CPn has a low voltage. Accordingly, pixels 140 that receive a scan signal during the i-th frame period iF are set to be in a non-emission state, and pixels 140 that do not receive a scan signal during the i-th frame period iF are set to be in an emission state.

A scan signal is sequentially supplied to the even-numbered scan lines S2, S4, . . . during an (i+1)-th frame period i+1 F. During this time, the second clock signal CLK2 supplied to the even-numbered clock supply lines CP2, CP4, . . . , CPn has a high voltage, and the first clock signal CLK1 supplied to the odd-numbered clock supply lines CP1, CP3, . . . , CPn−1 has a low voltage. Accordingly, pixels 140 that receive a scan signal during the (i+1)-th frame period 1+1 F are set to be in a non-emission state, and pixels 140 that do not receive a scan signal during the (i+1)-th frame period i+1F are set to be in an emission state.

In the second embodiment of the present invention, the pixels 140 are in an emission state or in a non-emission state corresponding to horizontal line arrangement, and based on frame periods. In this case, the emission and non-emission of the pixels 140 can be controlled using the two clock signals CLK1 and CLK2, thereby reducing manufacturing costs. Further, in the second embodiment of the present invention, one frame can be set to be more than 60 Hz, for example, 120 Hz.

Meanwhile, in the driving method of FIG. 6, high periods (or low periods) of the clock signals CLK1 and CLK2 overlap with one scan signal. However, the embodiment of the present invention is not limited thereto. Practically, the period when the high periods of the clock signals CLK1 and CLK2 overlap with the scan signals may be variously determined.

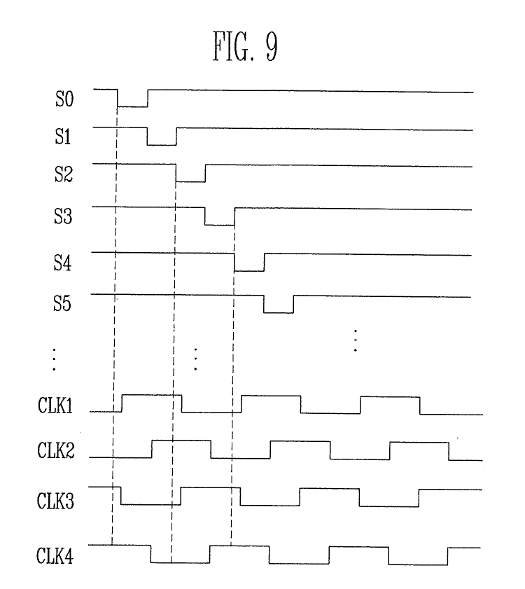

FIG. 8 is a waveform diagram illustrating a driving method according to a third embodiment of the present invention. For convenience, it is assumed that the control transistor MC is a PMOS transistor.

Referring to FIG. 8, high periods of clock signals CLK1 to CLK4 overlap with two scan signals. For example, when a threshold voltage of a driving transistor is compensated in the pixel circuit 142, the high period of each of the clock signals CLK1 to CLK4 may instead overlap with two scan signals.

Meanwhile, four clock signals, i.e., a first clock signal CLK1, a second clock signal CLK2, a third clock signal CLK3 and a fourth clock signal CLK4 are generated from the timing controller 150, such that the high periods of the clock signals CLK1 to CLK4 overlap with two scan signals.

The first clock signal CLK1 is supplied to j-th (where j is 1, 5, 9, . . . ) clock supply lines CPj. Here, the high voltage of the first clock signal CLK1 overlaps with scan signals supplied to a (j−1)-th scan line Sj−1 and a j-th scan line Sj. In this case, pixels 140 coupled to the j-th scan line Sj are set to be in a non-emission state during periods when the scan signals are supplied to the (j−1)-th scan line Sj−1 and the j-th scan line Sj, and to be in an emission state during periods when the scan signals are not supplied to the (j−1)-th scan line and the j-th scan line.

The second clock signal CLK2 is supplied to (j+1)-th clock supply lines CPj+1. Here, the high voltage of the second clock signal CLK2 overlaps with scan signals supplied to the j-th scan line Sj and a (j+1)-th scan line Sj+1. In this case, pixels 140 coupled to the (j+1)-th scan line Sj+1 are set to be in a non-emission state during periods when the scan signals are supplied to the j-th scan line Sj and the (j+1)-th scan line Sj+1, and to be in an emission state during periods when the scan signals are not supplied to the j-th scan line and the (j+1)-th scan line.

The third clock signal CLK3 is supplied to (j+2)-th clock supply lines CPj+2. Here, the high voltage of the third clock signal CLK3 overlaps with scan signals supplied to the (j+1)-th scan line Sj+1 and a (j+2)-th scan line Sj+2. In this case, pixels 140 coupled to the (j+2)-th scan line Sj+2 are set to be in a non-emission state during periods when the scan signal are supplied to the (j+1)-th scan line Sj+1 and the (j+2)-th scan line Sj+2, and to be in an emission state during periods when the scan signals are not supplied to the (j+1)-th scan line and the (j+2)-th scan line.

The fourth clock signal CLK4 is supplied to (j+3)-th clock supply lines CPj+3. Here, the high voltage of the fourth clock signal CLK4 overlaps with scan signals supplied to the (j+2)-th scan line Sj+2 and a (j+3)-th scan line Sj+3. In this case, pixels 140 coupled to the (j+3)-th scan line Sj+3 are set to be in a non-emission state during periods when the scan signals are supplied to the (j+2)-th scan line Sj+2 and the (j+3)-th scan line Sj+3, and to be in an emission state during periods when the scan signals are not supplied to the (j+2)-th scan line and the (j+3)-th scan line.

As described above, in the third embodiment of the present invention, the emission time of the pixels 140 can be controlled using four clock signals CLK1 to CLK4, thereby reducing manufacturing costs.

Meanwhile, in the fourth embodiment of the present invention, the high voltage of each of the first to fourth clock signals CLK1 to CLK4 may be set to overlap with scan signals during alternative periods as illustrated in FIG. 9. That is, the supply time of each of the clock signals CLK1 to CLK4 may be variously determined in accordance with various types of pixel circuits 142 current known in the art.

For example, in FIG. 9, the first clock signal CLK1 is supplied to j-th (j is 1, 5, 9, . . . ) clock supply lines CPj. Here, the high voltage of the first clock signal CLK1 overlaps with a portion of a period when a scan signal is supplied to a (j−1)-th scan line Sj−1 and to overlap with a scan signal supplied to a j-th scan line Sj. As illustrated in FIG. 9, a high first clock signal CLK1 may also be supplied to overlap with a portion of a period when a scan signal is supplied to a (j+1)-th scan line Sj+1.

The second clock signal CLK2 is supplied to (j+1)-th clock supply lines CPj+1. Here, the high voltage of the second clock signal CLK2 overlaps with a portion of a period when the scan signal is supplied to the j-th scan line Sj and to overlap with a scan signal supplied to a (j+1)-th scan line Sj+1. As illustrated in FIG. 9, a high second clock signal CLK2 may also be supplied to overlap with a portion of a period when a scan signal is supplied to a (j+2)-th scan line Sj+2.

The third clock signal CLK3 is supplied to (j+2)—the clock supply lines CPj+2.

Here, the high voltage of the third clock signal CLK3 overlaps with a portion of a period when the scan signal is supplied to the (j+1)-th scan line Sj+1 and to overlap with a scan signal supplied to a (j+2)-th scan line Sj+2. As illustrated in FIG. 9, a high third clock signal CLK3 may also be supplied to overlap with a portion of a period when a scan signal is supplied to a (j+3)-th scan line Sj+3.

The fourth clock signal CLK4 is supplied to (j+3)-th clock supply lines CPj+3. Here, the high voltage of the fourth clock signal CLK4 overlaps with a portion of a period when the scan signal is supplied to the (j+2)-th scan line Sj+2 and to overlap with a scan signal supplied to a (j+3)-th scan line Sj+3. As illustrated in FIG. 9, a high fourth clock signal CLK4 may also be supplied to overlap with a portion of a period when a scan signal is supplied to a (j+4)-th scan line Sj+4

While the present invention has been described in connection with certain exemplary embodiments, it is to be understood that the invention is not limited to the disclosed embodiments, but is instead intended to cover various modifications and equivalent arrangements included within the spirit and scope of the appended claims, and equivalents thereof.

What is claimed is:

1. An organic light emitting display, comprising:
a scan driver for sequentially supplying a scan signal to scan lines;
a data driver for supplying data signals to data lines when the scan signal is supplied;
a timing controller for controlling the scan driver and the data driver and for supplying one of at least two clock signals to clock supply lines arranged parallel to the scan lines; and
pixels positioned at crossing regions of the scan lines, the data lines and the clock supply lines,
wherein each of the pixels comprises:
an organic light emitting diode;
a pixel circuit for controlling an amount of current supplied along a current path from a first power source to a second power source via the organic light emitting diode; and
a control transistor on the current path and controlled by a corresponding clock signal of the at least two clock signals.

2. The organic light emitting display according to claim 1, wherein the timing controller is configured to supply a first clock signal of the at least two clock signals to odd-numbered clock supply lines of the clock supply lines and to supply a second clock signal of the at least two clock signals to even-numbered clock supply lines of the clock supply lines.

3. The organic light emitting display according to claim 2, wherein the first clock signal is configured to turn off the control transistor of a pixel corresponding to one of the odd-numbered clock supply lines of the pixels when the scan signal is supplied to odd-numbered scan lines of the scan lines, and to turn on the control transistor of the pixel when the scan signal is not supplied to the odd-numbered scan lines.

4. The organic light emitting display according to claim 2, wherein the second clock signal is configured to turn off the control transistor of a pixel corresponding to one of the even-numbered clock supply lines of the pixels when the scan signal is supplied to even-numbered scan lines of the scan lines, and to turn on the control transistor of the pixel when the scan signal is not supplied to the even-numbered scan lines.

5. The organic light emitting display according to claim 2, wherein the scan signal is sequentially supplied to odd-numbered scan lines of the scan lines during an i-th (i is an odd or even number) frame period, and is sequentially supplied to even-numbered scan lines of the scan lines during an (i+1)-th frame period.

6. The organic light emitting display according to claim 5, wherein the first clock signal is configured to turn off the control transistor of a pixel corresponding to one of the odd-numbered clock supply lines of the pixels during the i-th frame period, and to turn on the control transistor of the pixel during the (i+1)-th frame period.

7. The organic light emitting display according to claim 5, wherein the second clock signal is configured to turn off the control transistor of a pixel corresponding to one of the even-numbered clock supply lines of the pixels during the (i+1)-th frame period, and to turn on the control transistor of the pixel during the i-th frame period.

8. The organic light emitting display according to claim 1, wherein the timing controller is configured to supply a first clock signal of the at least two clock signals to j-th (j is 1, 5, 9, . . . ) clock supply lines of the clock supply lines, to supply a second clock signal of the at least two clock signals to (j+1)-th clock supply lines of the clock supply lines, to supply a third clock signal of the at least two clock signals to (j+2)-th clock supply lines of the clock supply lines, and to supply a fourth clock signal of the at least two clock signals to (j+3)-th clock supply lines of the clock supply lines.

9. The organic light emitting display according to claim 8, wherein each of the first, second, third, and fourth clock signals overlaps with at least a portion of the scan signal being sequentially supplied to two scan lines of the scan lines.

10. The organic light emitting display according to claim 9, wherein the first clock signal is configured to turn off the control transistor of a pixel corresponding to one of the j-th clock supply lines of the pixels during periods when the scan signal is supplied to (j−1)-th scan lines of the scan lines or j-th scan lines of the scan lines, and to turn on the control transistor of the pixel during periods when the scan signal is not supplied to the (j−1)-th scan lines or the j-th scan lines.

11. The organic light emitting display according to claim 9, wherein the second clock signal is configured to turn off the control transistor of a pixel corresponding to one of the (j+1)-th clock supply lines of the pixels during periods when the scan signal is supplied to j-th scan lines of the scan lines or (j+1)-th scan lines of the scan lines, and to turn on the control transistor of the pixel during periods when the scan signal is not supplied to the j-th scan lines or the (j+1)-th scan lines.

12. The organic light emitting display according to claim 9, wherein the third clock signal is configured to turn off the control transistor of a pixel corresponding to one of the (j+2)-th clock supply lines of the pixels during periods when the scan signal is supplied to (j+1)-th scan lines of the scan lines or (j+2)-th scan lines of the scan lines, and to turn on the control transistor of the pixel during periods when the scan signal is not supplied to the (j+1)-th scan lines or the (j+2)-th scan lines.

13. The organic light emitting display according to claim 9, wherein the fourth clock signal is configured to turn off the control transistor of a pixel corresponding to one of the (j+3)-th clock supply lines of the pixels during periods when the scan signal is supplied to (j+2)-th scan lines of the scan lines or (j+3)-th scan lines of the scan lines, and to turn on the control transistor of the pixel during periods when the scan signal is not supplied to the (j+2)-th scan lines or the (j+3)-th scan lines.

14. The organic light emitting display according to claim 9, wherein each of the first, second, third, and fourth clock signals overlaps with a portion of the scan signal being supplied to one of the two scan lines, and completely overlaps with a scan signal being supplied to the other one of the two scan lines.

15. A method of driving an organic light emitting display comprising pixels each having an organic light emitting diode, a pixel circuit for controlling an amount of current supplied along a current path from a first power source to a second power source via the organic light emitting diode, and a control transistor on the current path, the driving method comprising:
sequentially supplying a scan signal to scan lines;
supplying data signals to data lines when the scan signal is supplied; and
supplying one of at least two clock signals to clock supply lines arranged parallel to the scan lines to turn corresponding control transistors of the pixels on and off.

16. The method according to claim 15, wherein a first clock signal of the at least two clock signals is supplied to odd-numbered clock supply lines of the clock supply lines, and a second clock signal of the at least two clock signals is supplied to even-numbered clock supply lines of the clock supply lines.

17. The method according to claim 16, wherein the first clock signal turns off the control transistor of a pixel corresponding to one of the odd-numbered clock supply lines of the pixels when the scan signal is supplied to odd-numbered scan lines of the scan lines, and turns on the control transistor of the pixel when the scan signal is not supplied to the odd-numbered scan lines.

18. The method according to claim 16, wherein the second clock signal turns off the control transistor of a pixel corresponding to one of the even-numbered clock supply lines of the pixels when the scan signal is supplied to even-numbered scan lines of the scan lines, and turns on the control transistor of the pixel when the scan signal is not supplied to the even-numbered scan lines.

19. The method according to claim 16, wherein the scan signal is sequentially supplied to odd-numbered scan lines of the scan lines during an i-th (i is an odd or even number) frame period, and is sequentially supplied to even-numbered scan lines of the scan lines during an (i+1)-th frame period.

20. The method according to claim 19, wherein the first clock signal turns off the control transistor of a pixel corresponding to one of the odd-numbered clock supply lines of the pixels during the i-th frame period, and turns on the control transistor of the pixel during the (i+1)-th frame period.

21. The method according to claim 19, wherein the second clock signal turns off the control transistor of a pixel corresponding to one of the even-numbered clock supply lines of the pixels during the (i+1)-th frame period, and turns on the control transistor of the pixel during the i-th frame period.

22. The method according to claim 15, wherein:
a first clock signal of the at least two clock signals is supplied to j-th (j is 1, 5, 9, . . . ) clock supply lines of the clock supply lines;
a second clock signal of the at least two clock signals is supplied to (j+1)-th clock supply lines of the clock supply lines;
a third clock signal of the at least two clock signals is supplied to (j+2)-th clock supply lines of the clock supply lines; and
a fourth clock signal of the at least two clock signals is supplied to (j+3)-th clock supply lines of the clock supply lines.

23. The method according to claim 22, wherein each of the first, second, third, and fourth clock signals overlaps with a portion of the scan signal being sequentially supplied to two scan lines of the scan lines.
